(19) United States
(12) Patent Application Publication
(10) Pub. No.: US 2026/0280588 A1
(43) Pub. Date: Sep. 17, 2026

(54) Antenna Switching System for Connecting Antenna Elements to Form Combined Antennas

(71) Applicant: Zebra Technologies Corporation, Lincolnshire, IL (US)

(72) Inventors: Frank Chen, Taipei (TW); Wei-Yu Mu, Taipei (TW)

(21) Appl. No.: 19/078,431

(22) Filed: Mar. 13, 2025

(51) Int. Cl. H04B 1/00; H01Q 1/27; H01Q 5/20; H01Q 5/30; H01Q 5/50

(52) U.S. Cl. CPC H04B 1/0064; H01Q 1/27; H01Q 5/20; H01Q 5/30; H01Q 5/50

(57) ABSTRACT

Antenna modules and switching networks are disclosed. An antenna module can include a first antenna configured to process signals in a first frequency band. The antenna module can further include a second antenna configured to process signals in a second frequency band different from the first frequency band. The antenna module can further include a switching network connected to the first antenna and the second antenna. The switching network can, in a first switching state, electrically connect the first antenna and the second antenna to form a combined antenna to process signals in a third frequency band. The switching network can further, in a second switching state, electrically disconnect the first antenna and the second antenna to process signals in the first frequency band via the first antenna and signals in the second frequency band via the second antenna.

### BACKGROUND

Today, it is common to attach labels with radio frequency (RF) identification (RFID) tags to articles to help track and identify these articles during the regular course of business. Workers who handle these articles may then use mobile devices to gather information on these articles. The mobile devices typically include wireless communication systems such as a wireless wide area network (WWAN) systems or wireless local area network (WLAN) systems, among others, that utilize multiple radio frequency antennas to communicate on cellular frequencies, Wi-Fi frequencies, or satellite/global positioning system (GPS) frequencies, for example. The mobile devices typically include an accessory attachment and/or an additional antenna and circuitry to support RFID communications. However, space for providing antennas is often limited and it can be difficult to design circuitry for RFID antennas within available space.

There is a need to provide a solution for RFID communications that reduces or eliminates the amount of space used for RFID communication components.

### SUMMARY

In an embodiment, the present invention is an antenna module comprising: a first antenna configured to process signals in a first frequency band; a second antenna configured to process signals in a second frequency band different from the first frequency band; and a switching network connected to the first antenna and the second antenna, the switching network configured to: in a first switching state, electrically connect the first antenna and the second antenna to form a combined antenna configured to process signals in a third frequency band, and in a second switching state, electrically disconnect the first antenna and the second antenna and process: (a) the signals in the first frequency band via the first antenna and (b) the signals in the second frequency band via the second antenna.

In a variation of this embodiment, the switching network comprises a first switching element including: (a) a first position configured to electrically connect a signal input of the first antenna to process the first frequency band when the switching network is in the second switching state; and (b) a second position configured to electrically connect the signal input of the first antenna to process signals in the third frequency band when the switching network is in the first switching state.

In a variation of this embodiment, the switching network comprises a second switching element including: (a) a first portion configured to electrically connect a second port of the first antenna to a terminating impedance when the switching network is in the second switching state; and (b) a second portion configured to electrically connect the second port of the first antenna to a third switching element when the switching network is in the first switching state.

In a variation of this embodiment, the third switching element includes (a) a first portion configured to electrically connect the first port of the second antenna to a terminating impedance when the switching network is in the second switching state; and (b) a second portion configured to electrically connect the first port of the second antenna to the second switching element when the switching network is in the first switching state.

In a variation of this embodiment, the switching network comprises a fourth switching element including: (a) a first portion configured to electrically connect the second port of the second antenna to a terminating impedance when the switching network is in the first switching state; and (b) a second portion configured to electrically connect the second port of the second antenna to circuitry for processing the second frequency band when the switching network is in the second switching state.

In a variation of this embodiment, the terminating impedance comprises an open circuit. In a variation of this embodiment, the terminating impedance comprises an electrical ground.

In a variation of this embodiment, the antenna module further comprises a third antenna.

In a variation of this embodiment, the switching network comprises a fourth switching element including: a first portion configured to electrically connect the second port of the second antenna to a fifth switching element associated with the third antenna to change a resonant frequency of the combined antenna to process signals at a fourth frequency band lower than the third frequency band.

In a variation of this embodiment, the first frequency band is lower than the second frequency band. In a variation of this embodiment, the combined antenna is tuned to a resonance to process RFID signals. In a variation of this embodiment, the switching network further comprises circuitry to change a resonant frequency of at least one of the first antenna or the second antenna. In a variation of this embodiment, the first frequency band is within a frequency range of about 1-6 Gigahertz (GHz).

In another embodiment, the present invention is a method implemented in a computing device comprising at least a first antenna and a second antenna, the method comprising: connecting the first antenna to process signals in a first frequency band; connecting the second antenna to process signals in a second frequency band; and controlling a switching network to: in a first switching state, electrically connect the first antenna and the second antenna to form a combined antenna responsive to receiving a first switching signal; and in a second switching state, electrically disconnect the first antenna and the second antenna and process: (a) signals in the first frequency band via the first antenna and (b) signals in the second frequency band via the second antenna.

In a variation of this embodiment, the method further comprises controlling a first switching element to: (a) electrically connect a first port of the first antenna to process signals in the first frequency band when the switching network is in the first switching state; and (b) electrically connect the first port of the first antenna to process signals in a third frequency band when the switching network is in the second switching state.

In a variation of this embodiment, the method further comprises: controlling a second switching element to: (a) electrically connect the second port of the first antenna to a terminating impedance when the switching network is in the second switching state; and (b) electrically connect the second port of the first antenna to a third switching element when the switching network is in the first switching state.

In a variation of this embodiment, the method further comprises controlling the switching network to: (a) electrically connect the first port of the second antenna to ground when the switching network is in the second switching state; and (b) electrically connect the first port of the second antenna to the second switching element when the switching network is in the first switching state.

In a variation of this embodiment, the method further comprises: controlling the switching network to: (a) electrically connect the second port of the second antenna to a terminating impedance when the switching network is in the first switching state; and (b) electrically connect the second port of the second antenna to circuitry for processing the second frequency band when the switching network is in the second switching state.

In a variation of this embodiment, the method further comprises receiving a request to enter a radio frequency identification (RFID) mode of operation; and controlling the switching network to enter the first switching state in response to the request.

In a variation of this embodiment, the method further comprises performing impedance matching and/or tuning subsequent to controlling the switching network to tune antenna operations.

In another embodiment, the present invention is a system comprising: a housing; a first antenna configured to process signals in a first frequency band; a second antenna configured to process signals in a second frequency band different from the first frequency band; and a switching network connected to the first antenna and the second antenna, the switching network configured to: in a first switching state, electrically connect the first antenna and the second antenna to form a combined antenna configured to process signals in a third frequency band; and in a second switching state, electrically disconnect the first antenna and the second antenna and process: (a) the first frequency band via the first antenna and (b) the second frequency band via the second antenna.

In a variation of this embodiment, the system further comprises: a control device mounted to the housing and configured to control whether the system is to operate in a radio frequency identification (RFID) mode or in a cellular communication mode.

In another embodiment, the present invention is a switching network comprising: a first switching element including: (a) a first portion configured to electrically connect a first port of a first antenna to process signals in a first frequency band when the switching network is in a second switching state; and (b) a second portion configured to electrically connect a first port of the first antenna to process signals in a third frequency band when the switching network is in a first switching state; and a second switching element including: (a) a first portion configured to electrically connect a second port of the first antenna to a terminating impedance when the switching network is in the second switching state; and (b) a second portion configured to electrically connect the second port of the first antenna to a third switching element when the switching network is in the first switching state.

In a variation of this embodiment, third switching element includes: (a) a first portion configured to electrically connect the first port of a second antenna to a terminating impedance when the switching network is in the second switching state; and (b) a second portion configured to electrically connect the first port of the second antenna to the second switching element when the switching network is in the first switching state.

In a variation of this embodiment, the switching network can further comprise: a fourth switching element including: (a) a first portion configured to electrically connect the second port of the second antenna to a terminating impedance when the switching network is in the first switching state; and (b) a second portion configured to electrically connect the second port of the second antenna to circuitry for processing the second frequency band when the switching network is in the second switching state.

In a variation of this embodiment, the first portion of the fourth switching element is configured to electrically connect the second port of the second antenna to a fifth switching element associated with a third antenna to change a resonant frequency of the combined antenna to process signals in a fourth frequency band lower than the third frequency band.

In a variation of this embodiment, the terminating impedances further comprise circuitry to change a resonant frequency and/or port impedance of at least one of the first antenna or the second antenna.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention and explain various principles and advantages of those embodiments.

FIG. 1A is a rear view of a user device illustrating antenna configuration according to example embodiments.

FIG. 2A is a partial perspective cutaway view illustrating antenna ports for a user device according to example embodiments.

FIG. 2B is a partial perspective cutaway view illustrating antenna ports with an antenna combination according to example embodiments.

FIG. 3 is a block diagram of a system having an antenna module in which example embodiments can be implemented.

FIG. 4A illustrates a switching network in a first state according to example embodiments.

FIG. 4B illustrates a switching network in a second state according to example embodiments.

FIG. 5 illustrates S-parameters for two WWAN antennas and for an RFID antenna created through combination of two WWAN antennas according to example embodiments.

FIG. 6 illustrates radiation efficiency for two WWAN antennas and for an RFID antenna created through combination of the two WWAN antennas according to example embodiments.

FIGS. 7A-7B illustrate power for combined and uncombined antennas according to example embodiments.

FIGS. 8A-8B illustrate radiation efficiency for combined and uncombined antennas according to example embodiments.

FIG. 9A illustrates a switching network with an additional switching element and antenna in a first state according to example embodiments.

FIG. 9B illustrates a switching network with an additional switching element and antenna in a second state according to example embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

As previously mentioned, in some venues such as retail stores, warehouses, and similar locations, it is common to attach labels with RFID tags to articles. Users, such as store or warehouse workers, may use a wireless communication device to communicate with the RFID tags to track or identify articles during the regular course of business. These wireless communication devices often perform other communications in support of a user's personal or business needs, including for performing personal or business voice calls, text, emails, web browsing, location-based services and other activities. Therefore, the wireless communication devices can include one or more antennas configured to enable wireless communication with one or more access points of a wireless wide area network (WWAN), such as one or more base stations of a cellular communication network.

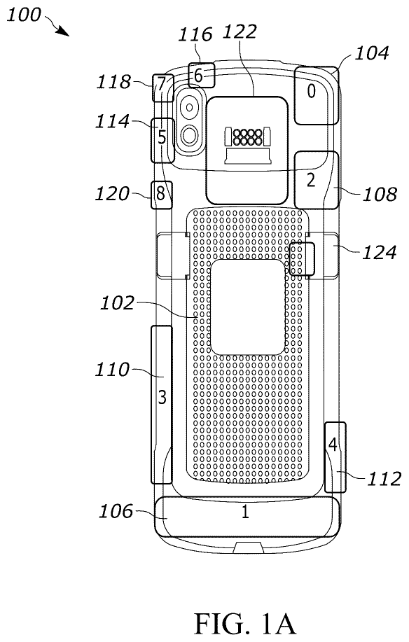

FIG. 1A is a rear view of a user device 100. The user device 100 includes a case or housing 102. The user device 100 may be a mobile device, e.g., a smartphone, tablet, or mobile computer. The user device may be configured for communication over multiple different frequency bands and, in some examples, over multiple different communication protocols, such as over a cellular network, a wireless local network, and/or over an RFID frequency band. The user device 100 uses antennas are configured to transmit and/or receive signals. For example, the antenna may be configured to enable wireless (e.g., radio frequency) communication with the wireless communication device. As an example, the antenna may include a dipole antenna, a multiple-input and multiple-output (MIMO) antenna, a planar inverted F antenna (PIFA), and/or the like. The antennas can be configured for receive only (PRX), transceive (e.g., both receiving and transmitting, TRX), and diversity receive (DRX). The antennas are situated within the housing 102 (e.g., in an enclosure) of the user device 100 and produce radiation patterns based on the design of the respective antenna, upon the position within the housing 102, and the positions and types of components used.

The antennas can be positioned within the case or housing 102 according to dashed outlines shown in FIG. 1A. For example, an antenna can be located at location 104, 106, 108, 110, 112, 114, 116, 118, and 120. The antennas can communicate over various frequency bands, in accordance with Institute of Electrical and Electronics Engineers (IEEE) standards, 3rd Generation Partnership Project (3GPP) standards, or other communication standards. While nine locations 104, 106, 108, 110, 112, 114, 116, 118, and 120 are shown, the user device 100 can include any number of antennas and communicate over any number of frequency bands.

The user device 100 can further include an RFID component 122, BLUETOOTH® or BLUETOOTH® Low Energy (BLE) components 124, and other components (not shown in FIG. 1). The RFID component 122 includes an RFID transceiver for communicating with RFID tags. It can be difficult to provide a dedicated antenna for RFID component 122 within the user device 100 due to lack of space on related circuit boards, for example. Therefore, systems, antenna modules, methods, and switching networks as described herein provide for sharing or combining existing antenna elements that resonate at higher frequencies, such as in the 2.4-3.65 GHz WWAN band and/or WLAN band, when operated separately, and resonate at a lower frequency, such as in the RFID 900 MHz band, when combined via a switching network arrangement described in further detail below. Notably, this removes the need for another antenna that is always dedicated to the lower band signals, such as RFID.

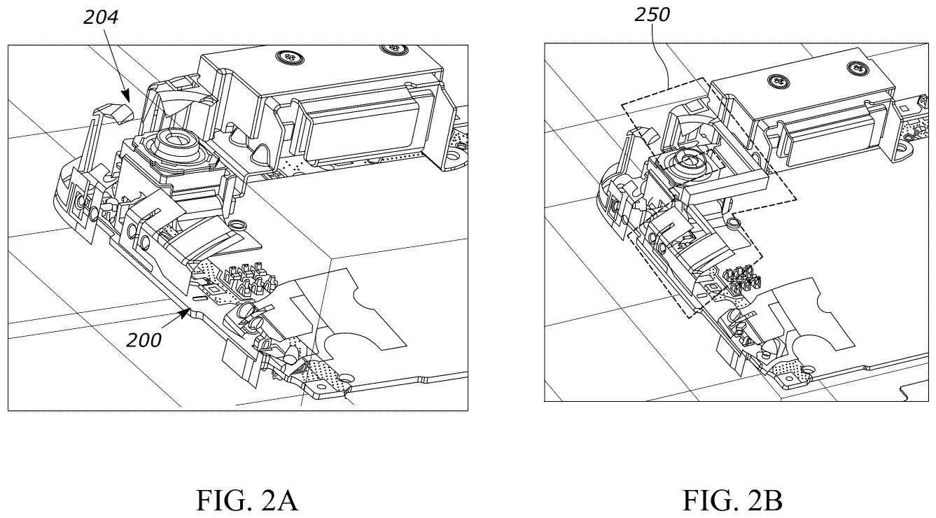

FIG. 2A is a partial perspective cutaway view illustrating antenna connection points, which include a location in which electrical connections can be made to antennas described herein. FIG. 2B is a partial perspective cutaway view illustrating antenna active elements. Referring to FIG. 2A, connection point 200 and connection point 204 can be mapped to different antennas to process signals of different frequency bands, while appropriate ports can serve as a functional interface for data transfer through those connection points. As such, the term “port” may be used when describing where electrical connections can be made in some embodiments. For example, connection point 200 (or “port”) can be mapped to antennas to process signals in a high frequency band (e.g., at or above 2.4 GHz WLAN bands) while connection point 206 can be mapped to antennas to process signals in a lower frequency band (e.g., at or below WWAN or WLAN bands). By comparison, in FIG. 2B, connection point 200 and connection point 204 can be connected as shown with the indication 250, using a switching network described later herein, to create a combined antenna.

While connection point 200 and connection point 204 are illustrated as connected, more than two connection points can be connected and other connection points (not shown) can be connected. In general, some embodiments can connect points for processing mid-and ultra-high-range frequency bands, although some specific embodiments can provide connected antennas for processing mid-and high-frequency bands. Example embodiments may not provide dedicated ports/antennas for processing low frequency bands because of the amount of space needed for antennas that process low-band signals. It will be understood that by combining two antennas into a combined antenna, the combined antenna has a lower resonating frequency and, therefore a longer wavelength that enables processing signals in a frequency that is lower than the frequency band of either of the two separate antennas. RFID antennas generally operate to process signals at a lower frequency than some WWAN and typically all WLAN frequencies of operation, and therefore combining two antennas that are normally dedicated to processing WWAN and/or WLAN signals results in a combined antenna that can process signals at a lower frequency than WWAN signals (e.g., RFID signals). Example WLAN frequencies are in bands that can include 2.4-3.65 GHz, and 4.9-5.0 GHz frequency bands. Example WWAN frequencies are in bands that include 700 MHz, 800 MHz, 1800 MHz, and 2600 MHz frequency bands.

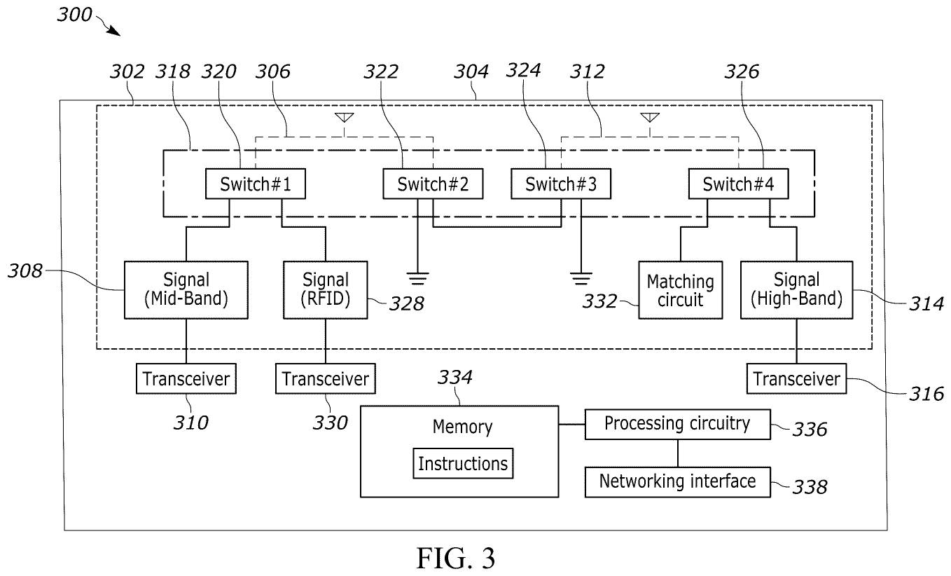

FIG. 3 is a block diagram of a system 300 having an antenna module 302 in which example embodiments can be implemented. The system 300 can be similar to the user device 100 shown in FIG. 1A. The system 300 can include a housing 304 similar to the housing 102 (FIG. 1A). The system 300 can process cellular, Wi-Fi and/or satellite/GPS signals as described earlier herein.

The antenna module 302 can include a first antenna 306 configured to process signals 308 of a first frequency band (e.g., any of the signals described earlier herein, including cellular, Wi-Fi or satellite signals) using, e.g., transceiver 310. In some examples, the signals 308 can be cellular (e.g., fifth generation (5G), 6G or later) mid-band signals (e.g., having a frequency in the range of 1-6 GHz) although embodiments are not limited thereto. The antenna module 302 can include a second antenna 312 configured to process signals 314 of a second frequency band (e.g., any of the signals described earlier herein, including cellular, Wi-Fi, or satellite signals) using, e.g., transceiver 316. In some examples, the signals 314 can be cellular (e.g., 5G, 6G or later) high-band signals (e.g., having a frequency in the range 2.4-5.0 GHz) or ultra-high-band (UHB) signals although embodiments are not limited thereto. In other embodiments, the system 300 can include additional antennas not shown in FIG. 3, including at least antennas at positions as illustrated in FIG. 1A, for processing other cellular, Wi-Fi, or satellite signals.

In an alternate embodiment, the antenna module 302 can include more than two antennas 306, 312. For example, the antenna module 302 can include a third antenna (not shown in FIG. 3) to process signals at a fourth frequency band different from or the same as one or more of the first frequency band, the second frequency band, or the third frequency band.

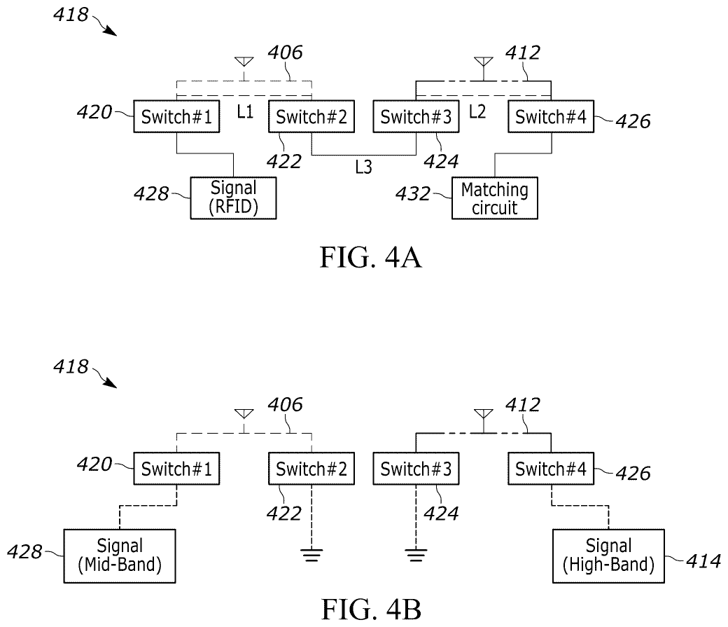

The system 300 can include a switching network 318 connected to at least the first antenna 306 and the second antenna 312. The switching network 318 can include a number of switching elements 320, 322, 324, and 326, although other switches (not shown) can be included. In other embodiments, the switching network 318 is described in more detail with reference to FIGS. 4A-4B. The system 300 can process signals 328 of other bands or types, including RFID signals, using, e.g., transceiver 330. Other circuitry or components can include circuitry 332, described in more detail later herein, for impedance matching and other antenna tuning.

The system 300 can include memory 334. The memory 334 can include one or more forms of volatile and/or non-volatile, fixed and/or removable memory, such as read-only memory (ROM), electronic programmable read-only memory (EPROM), random access memory (RAM), erasable electronic programmable read-only memory (EEPROM), and/or other hard drives, flash memory, MicroSD cards, and others.

The memory 334 can store computer-readable instructions. These instructions include instructions to control the switching network 318 according to any of the embodiments described herein using, e.g., processor 336. The switching network 318 can additionally or alternatively be controlled by external switches not shown in FIG. 3. In general, the computing instructions may be stored on a computer usable storage medium, or tangible, non-transitory computer-readable medium (e.g., standard random access memory (RAM), an optical disc, a universal serial bus (USB) drive, or the like) having such computer-readable program code or computer instructions embodied therein, wherein the computer-readable program code or computer instructions may be installed on or otherwise adapted to be executed by the one or more processors 336 to facilitate, implement, or perform the machine readable instructions, methods, processes, elements or limitations, as illustrated, depicted, or described for the various flowcharts, illustrations, diagrams, figures, and/or other disclosure herein, including switching network control or any other programs or software typically implemented on a mobile device operating a retail or warehouse environment. In this regard, the program code may be implemented in any desired program language, and may be implemented as machine code, assembly code, byte code, interpretable source code or the like (e.g., via Golang, Python, C, C++, C #, Objective-C, Java, Scala, ActionScript, JavaScript, HTML, CSS, XML, etc.). The processor 336 can include a microprocessor, controller, and/or any suitable type of processor.

Referring still to FIG. 3, the system 300 includes a networking interface 338 to enable communication with other machines and systems via, for example, one or more networks. The example networking interface 338 includes any suitable type of communication interface(s) (e.g., wired and/or wireless interfaces) configured to operate in accordance with any suitable protocol(s) (e.g., Ethernet for wired communications and/or IEEE 802.11 for wireless communications) e.g., using any of the antennas described above or wired connections. Other transceivers and circuitry of the system 300 can include a BLE radio transceiver or a networking interface to enable communication with other machines and systems via, for example, one or more networks. The networking interface 338 may be configured to communicate (e.g., send and receive) data via one or more external/network port(s) to one or more networks.

FIG. 4A and FIG. 4B illustrate the switching network 418 in a first and second state, respectively, according to example embodiments. In general, reference numerals in FIGS. 3-4B having the same least-significant digits can refer to similar components. For example, the antenna 306 (FIG. 3) can be similar to antenna 406, switching network 318 can be similar to switching network 418, switching element 320 can be similar to switching element 420, etc. The description provided for each can be similar with exceptions as noted below. The switching network 418 can receive requests through, for example, an external switch (not shown in FIGS. 4A-4B) to enter or exit an RFID mode of operation. Based on these requests, the switching network can enter the first or second switching state.

FIG. 4A illustrates the switching network 418 in a first switching state. In the first switching state, the switching network 418 can electrically connect the first antenna 406 and the second antenna 412 to form a combined antenna configured to process signals 428 in a third frequency band (e.g., RFID bands) of lower frequencies than the frequencies processed separately by either of the first antenna 406 and the second antenna 412. For example, the combined antenna has a longer wavelength that extends over a combined active radiator length L at least equal to the length L₁ of antenna 406 plus the length L₂ of antenna 412. Therefore, the combined antenna has a longer wavelength that processes signals in a frequency band lower than that processed by an antenna having a shorter wavelength of either L₁ or L₂.

Referring still to FIG. 4A which, illustrates the switching network 418 in a first switching state, it is noted that the combined antenna formed from first antenna 406 and second antenna 412 are connected via a conducting element between a second portion of the second switching element, and a second portion of the third switching element to enable operation at a third frequency band corresponding to the combined wavelength of length L₁ of the first antenna and length L₂ of the second antenna. In an embodiment, the length of the conducting element L₃, is effectively added to the L₁ and L₂ lengths but in practice is minimized such that it has no practical impact on the total wavelength or resulting operating frequency band.

FIG. 4B illustrates the switching network 418 in a second switching state. In the second switching state, the switching network 418 can electrically disconnect the first antenna 406 and the second antenna 412 and process: (a) the first frequency band 408 via the first antenna 406 and (b) the second frequency band 414 via the second antenna 412.

Referring both to FIG. 4A and FIG. 4B, the switching network 418 comprises a first switching element 420. The first switching element 420 includes a first portion to electrically connect a first port of the first antenna 406 to process the first frequency band 408 when the switching network 418 is in the second switching state. The first switching element 420 includes a second portion to electrically connect the first port of the first antenna to process the third frequency band 428 when the switching network is in the first switching state.

The switching network 418 comprises a second switching element 422. The second switching element 422 includes a first portion to electrically connect a second port of the first antenna 406 to ground when the switching network 418 is in the second switching state. The second switching element 422 includes a second portion to electrically connect the second port of the first antenna 406 to a third switching element 424 when the switching network 418 is in the first switching state. The third switching element 424 includes a first portion configured to electrically connect the first port of the second antenna 412 to ground when the switching network is in the second switching state. The third switching element 424 includes a second portion to electrically connect the first port of the second antenna 412 to the second switching element 422 when the switching network 418 is in the first switching state.

The switching network 418 comprises a fourth switching element 426. In some embodiments, the fourth switching element 426 may comprise a first portion to electrically connect the second port of the second antenna 412 to a terminating impedance 432 when the switching network 418 is in the first switching state. The terminating impedance 432 can comprise an impedance matching circuit or electrical ground, although embodiments are not limited thereto. For example, the terminating impedance 432 can include components to tune the resonance of the combined antenna to process signals 428 in the third frequency band.

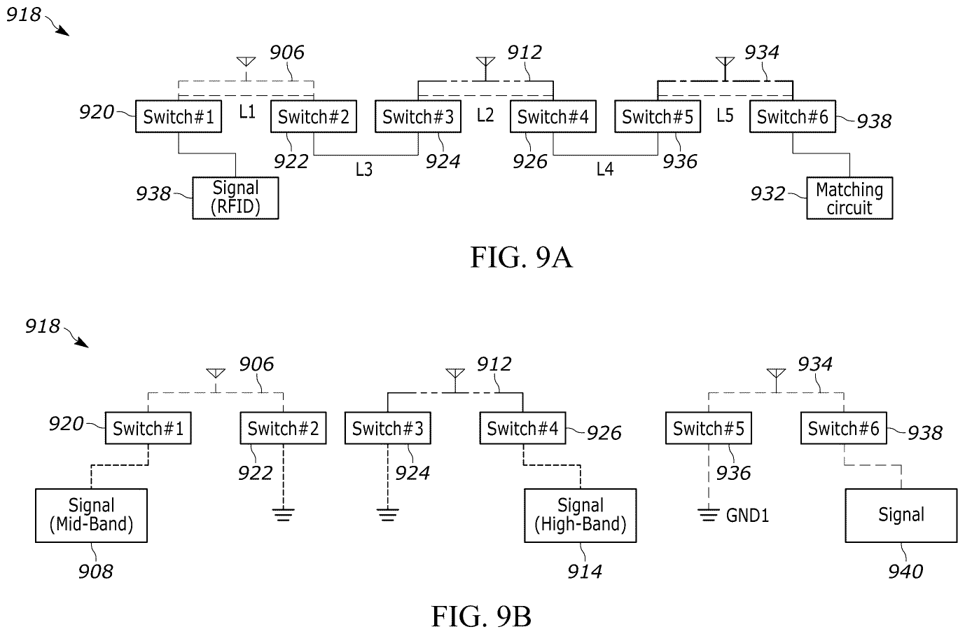

In some embodiments, the fourth switching element 426 can comprise a second portion to electrically connect the second port of the second antenna 412 to circuitry for processing the second frequency band 414 when the switching network 418 is in the second switching state. If the antenna module 302 (FIG. 3) includes additional antennas, the first portion of the fourth switching element 426 can be configured to electrically connect the second port of the second antenna 412 and additional switching elements as described in more detail with reference to FIGS. 9A-9B.

Antenna combination as described above can provide an antenna to process signals at lower frequencies when needed, while having minimal impact on other communications at higher frequencies. For example, when the switching network 318, 418 is operating in a second switching state (e.g., without RFID active), two antennas are available for non-RFID communication When the mid-, high-, or ultra-high band antennas are combined/shared to form an RFID antenna, losses are reduced relative to sharing a low-band antenna, and accordingly designs according to embodiments include sharing only between mid-, high-, or ultra-high band antennas.

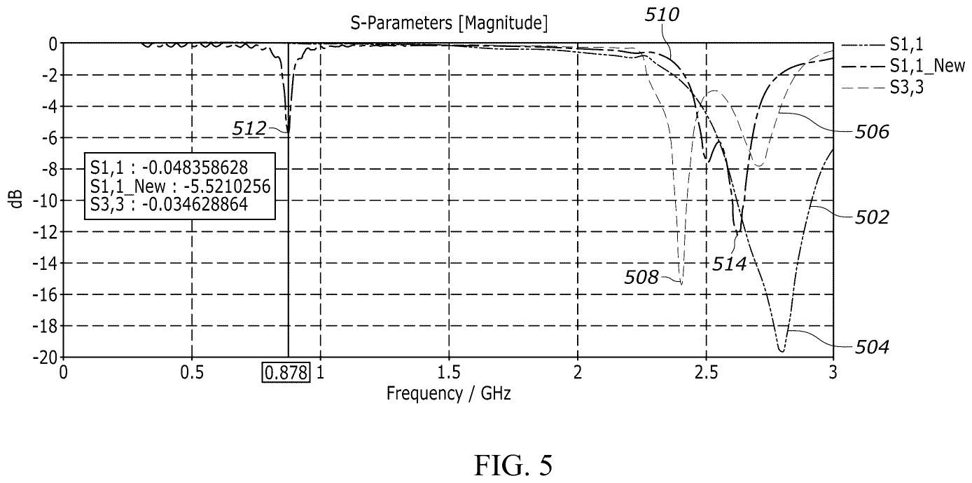

Antenna modules according to example embodiments allow formation of an RFID antenna without separate space for a dedicated RFID antenna, enabling the use of a compact antenna and circuit board design while still meeting all needs of mobile device users. Electrical and communication features of antennas are maintained as illustrated in FIGS. 5-8B.

FIG. 5 illustrates S-parameters for two WWAN antennas and for an RFID antenna created through combination of two WWAN antennas. First, curve 502 is an S-parameter curve for a first WWAN antenna having a resonant (or operating) frequency at point 504. Curve 506 is an S-parameter curve for a second WWAN antenna having a resonant/operating frequency at point 508. Curve 510 is an S-parameter curve for a combined RFID antenna having a resonant frequency at a lower frequency (point 512). A third harmonic frequency of 512 occurs at point 514.

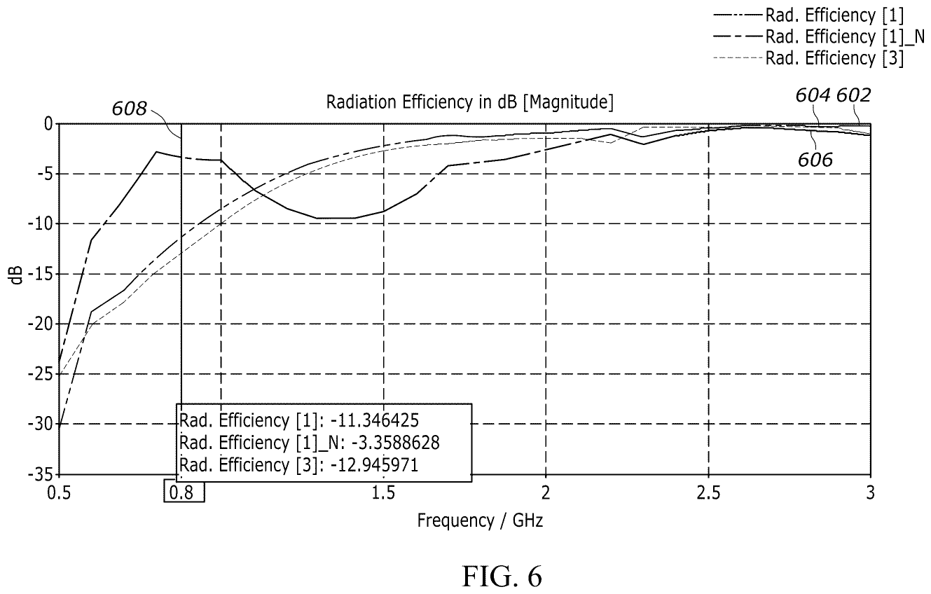

FIG. 6 illustrates radiation efficiency for two WWAN antennas and for an RFID antenna created through combination of the two WWAN antennas. First, curve 602 is a radiation efficiency curve for a first WWAN antenna, and curve 604 is a radiation efficiency curve for a second WWAN antenna. Curve 606 is a radiation efficiency curve for an RFID antenna created through combination of the two WWAN antennas. As seen by point 608, efficiency is very good at the operating frequency for the combined antenna, signifying good antenna characteristics for the combined RFID antenna.

It will be noted that a radiation pattern created by combining the WWAN antennas may be different than the separate radiating patterns created by each separate WWAN antenna. However, the variation in radiation patterns is created through use of multiple radiating elements and is a secondary effect of systems and antenna modules according to various embodiments. The overall RFID radiation pattern will depend on whether the RFID is short-range, mid-range, or long-range; however, systems according to embodiments may tend to be short-range and the overall radiating pattern may be less important in short-range scenarios.

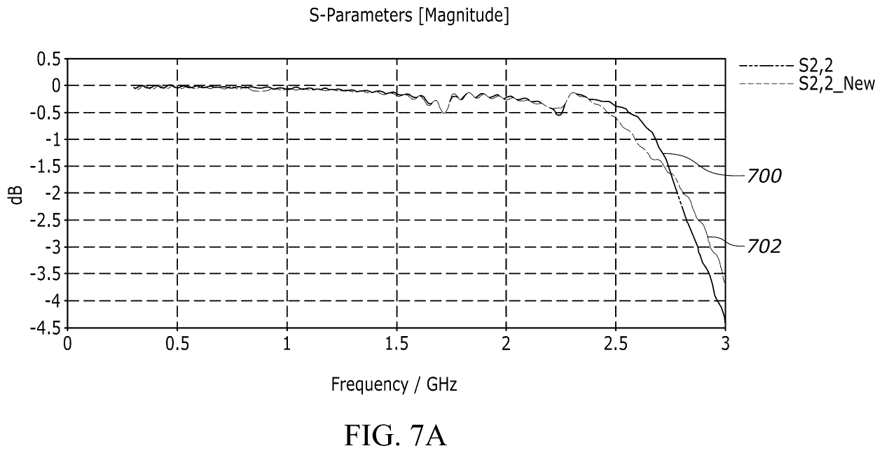

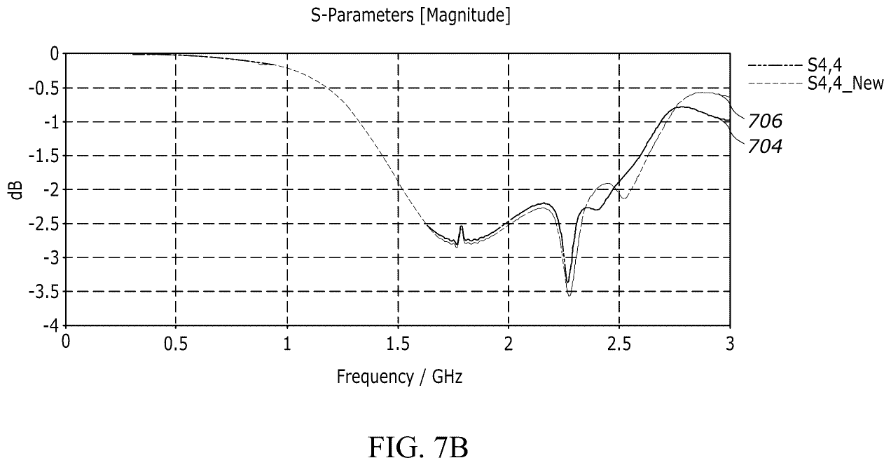

FIGS. 7A and 7B illustrate that power for uncombined antennas (e.g., at antenna port 202 and antenna port 204 illustrated in FIGS. 2A and 2B) remain unaffected after combination of WWAN antennas to form the one or more RFID antennas. First, referring to FIG. 7A, antenna port 202 before combination is shown at curve 700, and after combination at curve 702. It can be observed that little or no variation, reduction or change is seen in S-parameters for antenna port 202. Similarly, referring to FIG. 7B, antenna port 204 is shown before combination at curve 704 and after combination at curve 706. It can be observed that little or no variation, reduction or change is seen in S-parameters for antenna port 204.

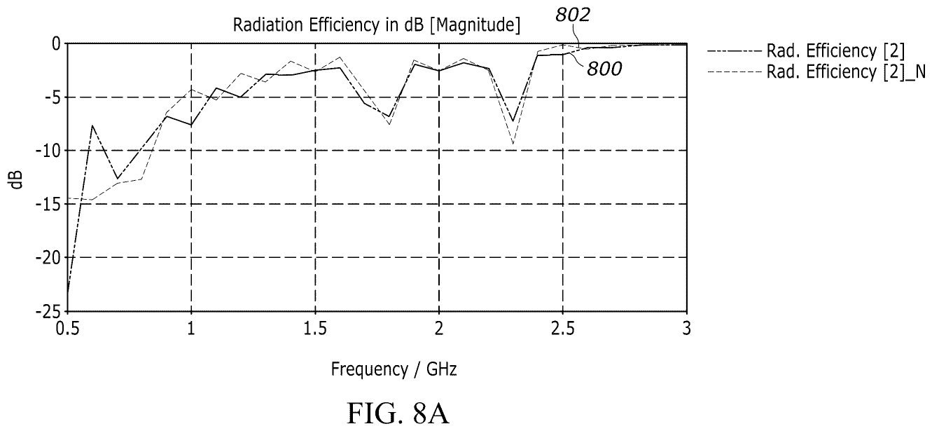

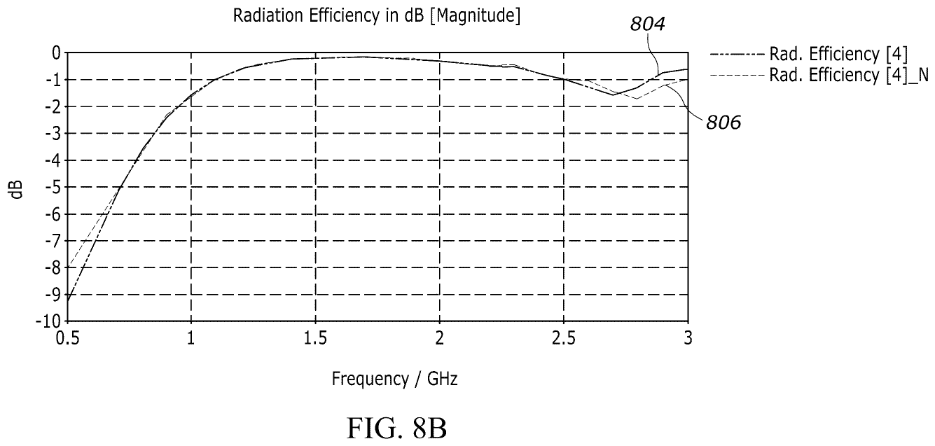

FIGS. 8A and 8B illustrate that radiation efficiency uncombined antennas (e.g., at antenna port 202 and antenna port 204 illustrated n FIGS. 2A and 2B) remain unaffected after combination of WWAN antennas to form the one or more RFID antennas. First, referring to FIG. 8A, antenna port 202 before combination is shown at curve 800, and after combination at curve 802. It can be observed that little or no variation, reduction or change is seen in radiation efficiency for antenna port 202. Similarly, referring to FIG. 8B, antenna port 204 is shown before combination at curve 804 and after combination at curve 806. It can be observed that little or no variation, reduction or change is seen in radiation efficiency for antenna port 204.

FIG. 9A and FIG. 9B illustrate the switching network 918 in a first and second state, respectively, according to example embodiments. In general, reference numerals in FIGS. 9A-9B having the same least-significant digits as those in FIGS. 3-4B can refer to similar components. For example, the antenna 306 (FIG. 3) can be similar to antenna 906, switching network 318 can be similar to switching network 918, etc. The description provided for each can be similar with exceptions as noted below.

As mentioned earlier herein, the antenna module (e.g., module 302, FIG. 3) can include more than two antennas. If the antenna module includes additional antennas, the first position of the fourth switching element 926 can be configured to electrically connect the signal portion of the second antenna 912 to a fifth switching element 936 associated with a third antenna 934 to change a resonant frequency of the combined antenna.

FIG. 9A illustrates an embodiment of the switching network 918 in a first switching state. In the first switching state, the switching network 918 can electrically connect the first antenna 906 the second antenna 912, and the third antenna 934 to form a combined antenna configured to process signals 938. For example, an embodiment of the combined antenna has an increased wavelength corresponding to an active radiator of length L at least equal to the length L₁ of antenna 906 plus the length L₂ of antenna 912 plus the length L₃ between switching element 922 and switching element 924, plus the length L₄ between the switching element 926 and 936, plus the length L₅ of antenna 934. In an embodiment, the connecting lengths L₃ and L₄ are minimized to reduce or eliminate their effect on the combined antenna wavelength. The combined antenna processes signals in a frequency band inversely proportional to combined length L (e.g., frequencies in a lower band than that processed by an antenna having a shorter length of either L₁, L₂ or L₅).

FIG. 9B illustrates the switching network 918 in a second switching state. In the second switching state, the switching network 918 can electrically disconnect the first antenna 906, the second antenna 912, and the third antenna 934 to process: (a) the first frequency band 908 via the first antenna 906, (b) the second frequency band 914 via the second antenna 912 and another frequency band 938 via the third antenna 934. Referring both to FIG. 9A and FIG. 9B, the switching network 918 comprises a fifth switching element 936. The fifth switching element 936 includes or can be configured in a first position to electrically connect a ground input of the third antenna 934 to ground, and in a second position to electrically connect the ground input of the third antenna 934 to the fourth switch 926. Similarly, a sixth switch can be configured to connect the signal input of the third antenna 934 to a matching circuit 932 or to process signals 940 in a signal band.

### ADDITIONAL CONSIDERATIONS

The above description refers to a block diagram of the accompanying drawings. Alternative implementations of the example represented by the block diagram includes one or more additional or alternative elements, processes and/or devices. Additionally, or alternatively, one or more of the example blocks of the diagram may be combined, divided, re-arranged or omitted. Components represented by the blocks of the diagram are implemented by hardware, software, firmware, and/or any combination of hardware, software and/or firmware. In some examples, at least one of the components represented by the blocks is implemented by a logic circuit. As used herein, the term “logic circuit” is expressly defined as a physical device including at least one hardware component configured (e.g., via operation in accordance with a predetermined configuration and/or via execution of stored machine-readable instructions) to control one or more machines and/or perform operations of one or more machines. Examples of a logic circuit include one or more processors, one or more coprocessors, one or more microprocessors, one or more controllers, one or more digital signal processors (DSPs), one or more application specific integrated circuits (ASICs), one or more field programmable gate arrays (FPGAs), one or more microcontroller units (MCUs), one or more hardware accelerators, one or more special-purpose computer chips, and one or more system-on-a-chip (SoC) devices. Some example logic circuits, such as ASICs or FPGAs, are specifically configured hardware for performing operations (e.g., one or more of the operations described herein and represented by the flowcharts of this disclosure, if such are present). Some example logic circuits are hardware that executes machine-readable instructions to perform operations (e.g., one or more of the operations described herein and represented by the flowcharts of this disclosure, if such are present). Some example logic circuits include a combination of specifically configured hardware and hardware that executes machine-readable instructions. The above description refers to various operations described herein and flowcharts that may be appended hereto to illustrate the flow of those operations. Any such flowcharts are representative of example methods disclosed herein. In some examples, the methods represented by the flowcharts implement the apparatus represented by the block diagrams. Alternative implementations of example methods disclosed herein may include additional or alternative operations. Further, operations of alternative implementations of the methods disclosed herein may combined, divided, re-arranged or omitted. In some examples, the operations described herein are implemented by machine-readable instructions (e.g., software and/or firmware) stored on a medium (e.g., a tangible machine-readable medium) for execution by one or more logic circuits (e.g., processor(s)). In some examples, the operations described herein are implemented by one or more configurations of one or more specifically designed logic circuits (e.g., ASIC(s)). In some examples the operations described herein are implemented by a combination of specifically designed logic circuit(s) and machine-readable instructions stored on a medium (e.g., a tangible machine-readable medium) for execution by logic circuit(s).

As used herein, each of the terms “tangible machine-readable medium,” “non-transitory machine-readable medium” and “machine-readable storage device” is expressly defined as a storage medium (e.g., a platter of a hard disk drive, a digital versatile disc, a compact disc, flash memory, read-only memory, random-access memory, etc.) on which machine-readable instructions (e.g., program code in the form of, for example, software and/or firmware) are stored for any suitable duration of time (e.g., permanently, for an extended period of time (e.g., while a program associated with the machine-readable instructions is executing), and/or a short period of time (e.g., while the machine-readable instructions are cached and/or during a buffering process)). Further, as used herein, each of the terms “tangible machine-readable medium,” “non-transitory machine-readable medium” and “machine-readable storage device” is expressly defined to exclude propagating signals. That is, as used in any claim of this patent, none of the terms “tangible machine-readable medium,” “non-transitory machine-readable medium,” and “machine-readable storage device” can be read to be implemented by a propagating signal.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. Additionally, the described embodiments/examples/implementations should not be interpreted as mutually exclusive, and should instead be understood as potentially combinable if such combinations are permissive in any way. In other words, any feature disclosed in any of the aforementioned embodiments/examples/implementations may be included in any of the other aforementioned embodiments/examples/implementations.

The benefits, advantages, solutions to problems, and any element(s) that may cause any benefit, advantage, or solution to occur or become more pronounced are not to be construed as a critical, required, or essential features or elements of any or all the claims. The claimed invention is defined solely by the appended claims including any amendments made during the pendency of this application and all equivalents of those claims as issued.

Moreover, in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter may lie in less than all features of a single disclosed embodiment. Thus, the following claims are hereby incorporated into the Detailed Description, with each claim standing on its own as a separately claimed subject matter.

We claim:

1. An antenna module comprising:
a first antenna configured to process signals in a first frequency band;
a second antenna configured to process signals in a second frequency band different from the first frequency band; and
a switching network connected to the first antenna and the second antenna, the switching network configured to:
in a first switching state, electrically connect the first antenna and the second antenna to form a combined antenna configured to process signals in a third frequency band; and
in a second switching state, electrically disconnect the first antenna and the second antenna and process: (a) the signals in the first frequency band via the first antenna and (b) the signals in the second frequency band via the second antenna.

2. The antenna module of claim 1, wherein the switching network comprises a first switching element including:
(a) a first position configured to electrically connect a signal input of the first antenna to process the first frequency band when the switching network is in the second switching state; and
(b) a second position configured to electrically connect the signal input of the first antenna to process signals in the third frequency band when the switching network is in the first switching state.

3. The antenna module of claim 2, wherein the switching network comprises a second switching element including:
(a) a first portion configured to electrically connect a second port of the first antenna to a terminating impedance when the switching network is in the second switching state; and
(b) a second portion configured to electrically connect the second port of the first antenna to a third switching element when the switching network is in the first switching state.

4. The antenna module of claim 3, wherein the third switching element includes:
(a) a first portion configured to electrically connect the first port of the second antenna to a terminating impedance when the switching network is in the second switching state; and
(b) a second portion configured to electrically connect the first port of the second antenna to the second switching element when the switching network is in the first switching state.

5. The antenna module of claim 4, wherein the switching network comprises a fourth switching element including:
(a) a first portion configured to electrically connect the second port of the second antenna to a terminating impedance when the switching network is in the first switching state; and
(b) a second portion configured to electrically connect the second port of the second antenna to circuitry for processing the second frequency band when the switching network is in the second switching state.

6. The antenna module of claim 5, wherein the terminating impedance comprises an open circuit.

7. The antenna module of claim 5, wherein the terminating impedance comprises an electrical ground.

8. The antenna module of claim 2, further comprising a third antenna.

9. The antenna module of claim 8, wherein the switching network comprises a fourth switching element including:
a first portion configured to electrically connect the second port of the second antenna to a fifth switching element associated with the third antenna to change a resonant frequency of the combined antenna to process signals in a fourth frequency band lower than the third frequency band.

10. The antenna module of claim 1, wherein the first frequency band is lower than the second frequency band.

11. The antenna module of claim 1, further comprising circuitry to process radio frequency identification (RFID) signals.

12. The antenna module of claim 11, wherein the combined antenna is tuned to a resonance to process RFID signals.

13. The antenna module of claim 1, wherein a resonant frequency of the combined antenna is lower than respective resonant frequencies of at least one of the first antenna and the second antenna.

14. The antenna module of claim 1, wherein the first frequency band is within a frequency range of about 1-6 Gigahertz (GHz).

15. A method implemented in a computing device comprising at least a first antenna and a second antenna, the method comprising:
connecting the first antenna to process signals in a first frequency band;
connecting the second antenna to process signals in a second frequency band; and
controlling a switching network to:
in a first switching state, electrically connect the first antenna and the second antenna to form a combined antenna responsive to receiving a first switching signal; and
in a second switching state, electrically disconnect the first antenna and the second antenna and process: (a) the signals in the first frequency band via the first antenna and (b) the signals in the second frequency band via the second antenna.

16. The method of claim 15, further comprising:
controlling a first switching element to:
(a) electrically connect a first port of the first antenna to process signals in the first frequency band when the switching network is in the first switching state; and
(b) electrically connect the first port of the first antenna to process signals in a third frequency band when the switching network is in the second switching state.

17. The method of claim 16, further comprising:
controlling a second switching element to:
(a) electrically connect a second port of the first antenna to a terminating impedance when the switching network is in the second switching state; and
(b) electrically connect the second port of the first antenna to a third switching element when the switching network is in the first switching state.

18. The method of claim 17, further comprising:
controlling the switching network to:
(a) electrically connect the first port of the second antenna to ground when the switching network is in the second switching state; and
(b) electrically connect the first port of the second antenna to the second switching element when the switching network is in the first switching state.

19. The method of claim 16, further comprising:
controlling the switching network to:
(a) electrically connect the second port of the second antenna to a terminating impedance when the switching network is in the first switching state; and
(b) electrically connect the second port of the second antenna for processing the second frequency band when the switching network is in the second switching state.

20. The method of claim 15, further comprising:
receiving a request to enter a radio frequency identification (RFID) mode of operation; and
controlling the switching network to enter the first switching state in response to the request.

21. The method of claim 15, further comprising:
performing impedance matching or tuning subsequent to controlling the switching network to tune antenna operations.

22. A system comprising:
a housing;
a first antenna configured to process signals in a first frequency band;
a second antenna configured to process signals in a second frequency band different from the first frequency band; and
a switching network connected to the first antenna and the second antenna, the switching network configured to:
in a first switching state, electrically connect the first antenna and the second antenna to form a combined antenna configured to process signals in a third frequency band; and
in a second switching state, electrically disconnect the first antenna and the second antenna and process: (a) the first frequency band via the first antenna and (b) the second frequency band via the second antenna.

23. The system of claim 22, further comprising:
a control device mounted to the housing and configured to control whether the system is to operate in a radio frequency identification (RFID) mode or in a cellular communication mode.

24. A switching network comprising:
a first switching element including:
(a) a first portion configured to electrically connect a first port of a first antenna to process signals in a first frequency band when the switching network is in a second switching state; and
(b) a second portion configured to electrically connect a second port of the first antenna to process signals in a third frequency band when the switching network is in a first switching state; and
a second switching element including:
(a) a first portion configured to electrically connect a second port of the first antenna to a terminating impedance when the switching network is in the second switching state; and
(b) a second portion configured to electrically connect the second port of the first antenna to a third switching element when the switching network is in the first switching state.

25. The switching network of claim 24, wherein the third switching element includes:
(a) a first portion configured to electrically connect the first port of a second antenna to a terminating impedance when the switching network is in the second switching state; and
(b) a second portion configured to electrically connect the first port of the second antenna to the second switching element when the switching network is in the first switching state.

26. The switching network of claim 24, further comprising:
a fourth switching element including:
(a) a first portion configured to electrically connect the second port of the second antenna to a terminating impedance when the switching network is in the first switching state; and
(b) a second portion configured to electrically connect the second port of the second antenna to circuitry for processing the second frequency band when the switching network is in the second switching state.

27. The switching network of claim 26, wherein the first portion of the fourth switching element is configured to:
electrically connect the second port of the second antenna to a fifth switching element associated with a third antenna to change a resonant frequency of the combined antenna to process signals in a fourth frequency band lower than the third frequency band.

28. The switching network of claim 26, wherein the terminating impedances further comprise circuitry to change a resonant frequency or port impedance of at least one of the first antenna or the second antenna.
